(19) United States
(12) Patent Application Publication
(10) Pub. No.: US 2026/0195943 A1
(43) Pub. Date: Jul. 9, 2026

(54) DETECTING GENERATED IMAGES PROMPTED WITH ARTIST NAMES

(71) Applicant: Adobe Inc., San Jose, CA (US)

(72) Inventors: Grace Su, Pittsburgh, PA (US); Sheng-Yu Wang, Pittsburgh, PA (US); Aaron Phillip Hertzmann, San Francisco, CA (US); Elya Shechtman, Seattle, WA (US); Jun-Yan Zhu, Cambridge, MA (US); Richard Zhang, San Francisco, CA (US)

(21) Appl. No.: 19/012,593

(22) Filed: Jan. 7, 2025

(51) Int. Cl. G06T 11/60

(52) U.S. Cl. CPC G06T 11/60; G06T 2200/24

(57) ABSTRACT

The present disclosure relates to systems, non-transitory computer-readable media, and methods for detecting generated images prompted with artist names or generated by artist-customized image generation models. In particular, in some embodiments, the disclosed systems determine, by at least one processor, a digital image generated by an image generation neural network. In addition, in some embodiments, the disclosed systems process the digital image utilizing an artist prompt prediction neural network trained to detect synthetic images generated from artist prompts comprising indications of specific artists. Moreover, in some embodiments, the disclosed systems generate, utilizing the artist prompt prediction neural network, a prompt type label for the digital image indicating whether the digital image was generated from an artist prompt comprising an indication of a specific artist.

### BACKGROUND

Generative artificial intelligence tools have made content creation faster and more accessible, while also accelerating artist style replication. For example, content creators sometimes prompt an image generation neural network with a specific artist's name to replicate an artistic style of the artist in the generated image. Additionally, some image generation neural networks are trained to reproduce styles of specific artists from datasets including images/paintings created by the specific artists. Due to the nature of neural networks and the unavailability of either prompts for generated images or training datasets for many image generation neural networks, detecting that an image has been generated to replicate a particular artist's style is a challenging task. Indeed, existing image analysis systems are unable to detect that an image has been generated to replicate a style of a particular artist.

### BRIEF SUMMARY

Embodiments of the present disclosure provide benefits and/or solve one or more problems in the art with systems, non-transitory computer-readable media, and methods for detecting digital images generated from artist prompts or by artist-customized image generation models. To illustrate, in some implementations, the disclosed systems use a neural network to generate a prompt type label indicating whether a digital image was generated from an artist prompt that identifies a particular artist. For example, in some embodiments, the disclosed systems prepare a dataset to train the neural network to detect artist-prompted images. More specifically, in some implementations, the disclosed systems generate the dataset from batches of artist-prompted images, style-prompted images, and content-prompted images. Additionally, in some embodiments, the disclosed systems train the neural network to generate labels that identify whether an image is likely artist-prompted, style-prompted, or content-prompted. Furthermore, in some implementations, the disclosed systems determine that an image was generated by a customized generative model that has been finetuned on artist-specific images.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an artist-based image detection system operates in accordance with one or more embodiments.

FIG. 2 illustrates the artist-based image detection system generating a prompt type label for a digital image in accordance with one or more embodiments.

FIG. 3 illustrates the artist-based image detection system utilizing an artist prompt prediction neural network to generate a prompt type label, a prompt name label, and an image source label for a digital image in accordance with one or more embodiments.

FIG. 4 illustrates the artist-based image detection system generating a customized model label for a digital image in accordance with one or more embodiments.

FIG. 5 illustrates the artist-based image detection system generating a training dataset for an artist prompt prediction neural network in accordance with one or more embodiments.

FIG. 6 illustrates the artist-based image detection system modifying parameters of an artist prompt prediction neural network in accordance with one or more embodiments.

FIG. 7 illustrates the artist-based image detection system providing a prompt type label for a digital image for display via a graphical user interface of a client device in accordance with one or more embodiments.

FIG. 8 illustrates a diagram of an example architecture of the artist-based image detection system in accordance with one or more embodiments.

FIG. 9 illustrates a flowchart of a series of acts for detecting generated images prompted with specific artist names in accordance with one or more embodiments.

FIG. 10 illustrates a block diagram of an example computing device for implementing one or more embodiments of the present disclosure.

### DETAILED DESCRIPTION

This disclosure describes one or more embodiments of an artist-based image detection system that determines whether a digital image has been generated from an artist prompt that identifies a particular artist whose style the image should replicate or via a model trained on an artist's images. For example, in some implementations, the artist-based image detection system utilizes an artist prompt prediction neural network to generate a prompt type label indicating whether a digital image was generated from an artist prompt naming a specific artist. To illustrate, in some embodiments, the artist-based image detection system generates a dataset (e.g., including batches of artist-prompted images, style-prompted images, and content-prompted images) to train the artist prompt prediction neural network to detect artist-prompted images. Additionally, in some embodiments, the artist-based image detection system trains the artist prompt prediction neural network to generate labels that identify whether an image is likely artist-prompted, style-prompted, or content-prompted.

Additionally, or alternatively, in some embodiments, the artist-based image detection system determines that an image was generated by a customized generative model that has been finetuned on artist-specific images. For example, the artist-based image detection system utilizes an artist customized model prediction neural network to generate a customized model label indicating whether a digital image was generated by an image generation model that was finetuned on works of a particular artist to generate new images in the style of that particular artist. Thus, in some embodiments, the artist-based image detection system detects digital images that were generated by models in a customization pipeline, in which the pretrained image generation model is specifically tuned towards replicating the style of a set of exemplary images of a specific artist.

Although some existing systems classify styles of digital images, such systems are unable to identify that a digital image was generated from an artist prompt. For instance, some existing systems measure a style similarity between a generated image and an average style representation to determine whether the generated image replicates a style. However, style similarity does not indicate that an image was made with a given artist's style as inspiration (either explicitly in a prompt or via training of a particular image generation model on an artist's work).

Additionally, some existing systems attempt to reverse engineer a prompt given as input to a text-to-image model to generate the image. Indeed, some existing systems can recover strings of key words that generally describe an image (e.g., by describing the content of the image). However, the recovered words often are not in the form of natural language phrases and do not include proper nouns (such as artist names). Thus, existing systems are limited in the amount of information that they can determine from their analysis of the images. Specifically, the existing systems are completely unable to detect specificity regarding individual artist inspiration for a particular image.

The artist-based image detection system provides improvements over existing systems that analyze the content and creation context of digital images. For example, the artist-based image detection system provides a novel technique for determining that a synthetic image was generated from an artist prompt naming a specific artist for style replication. As another example, the artist-based image detection system provides new capability of determining that a synthetic image was generated by a customized image generation model. Specifically, the artist-based image detection system utilizes one or more neural networks trained on a customized training dataset to detect whether a synthetically generated image is inspired by a particular artist, and in some cases which artist. Moreover, experimental results demonstrate that the artist-based image detection system is effective at identifying artist-based images, including on images generated from artist prompts of artists unseen during training.

Moreover, in some embodiments, the artist-based image detection system curates a training dataset and trains a multi-label classification model (e.g., the artist prompt prediction neural network and artist customized model prediction neural network described below) to detect generated images prompted with artist names or generated by customized image generation models. In particular, the artist-based image detection system generates a training dataset including a set of real images and synthetically generated images with specific artist labels, style labels, and content labels for training the multi-label classification model. Accordingly, in contrast to conventional systems that are only able to estimate specific styles, the artist-based image detection system provides detection of specific artist influence on synthetic image generation.

As described in further detail below, the artist-based image detection system demonstrates effective performance of detecting artist-prompted images and artist-conditioned images. Moreover, in addition to achieving good preliminary results, the artist-based image detection system has demonstrated that it generalizes well to unseen artists and image content (e.g., content for which the neural networks are not specifically trained). Additionally, on a subset of artists, the artist-based image detection system achieves high-precision detection of artist-conditioned images. Thus, the artist-based image detection system improves on conventional systems by creating a scalable approach for flagging likely instances of creator style replication to fairly attribute creators and keep pace with rapid development and adoption of generative artificial intelligence.

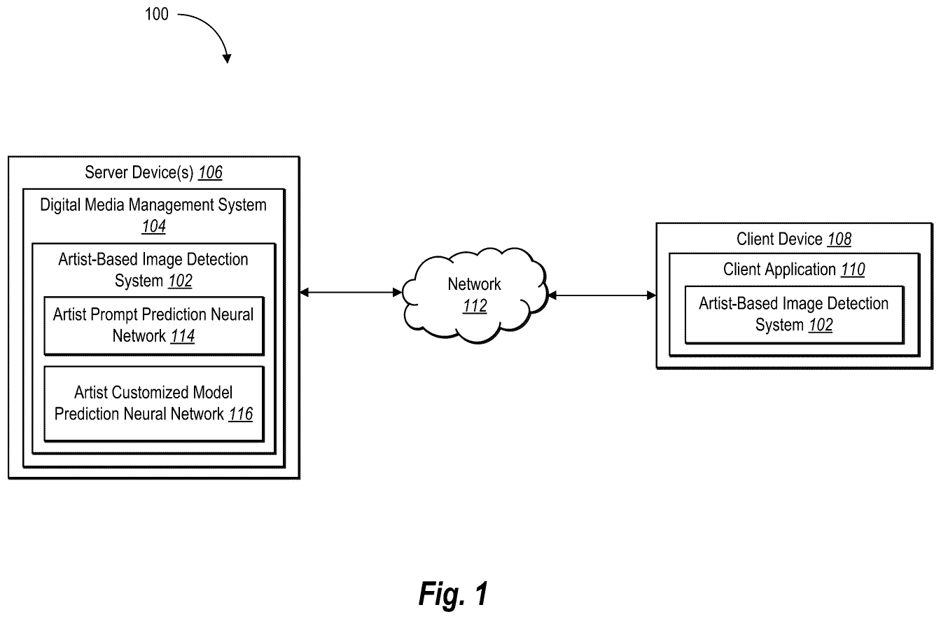

Additional detail will now be provided in relation to illustrative figures portraying example embodiments and implementations of an artist-based image detection system. For example, FIG. 1 illustrates a system 100 (or environment) in which an artist-based image detection system 102 operates in accordance with one or more embodiments. As illustrated, the system 100 includes server device(s) 106, a network 112, and a client device 108. As further illustrated, the server device(s) 106 and the client device 108 communicate with one another via the network 112.

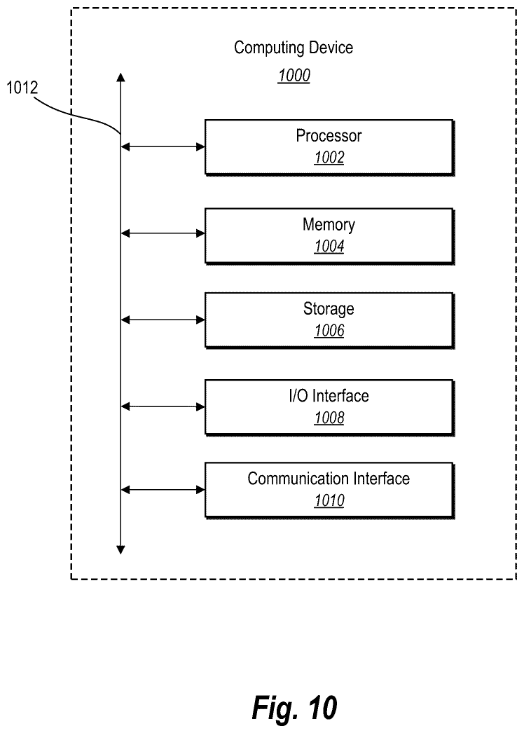

As shown in FIG. 1, the server device(s) 106 includes a digital media management system 104 that further includes the artist-based image detection system 102. According to one or more embodiments, the digital media management system 104 manages digital images used or generated via one or more client applications (e.g., for generating, editing, and/or analyzing digital images via various tools). Additionally, in some embodiments, the artist-based image detection system 102 utilizes one or more machine learning models to generate classification labels for a digital image. For example, in some implementations, the artist-based image detection system 102 utilizes an artist prompt prediction neural network 114 to generate a prompt type label indicating whether a digital image was generated from an artist prompt comprising an indication (e.g., a name) of a particular artist. As another example, in some implementations, the artist-based image detection system 102 utilizes an artist customized model prediction neural network 116 to generate a customized model label indicating whether a digital image was generated by a customized image generation neural network finetuned with artist-specific image data. In some embodiments, the server device(s) 106 includes, but is not limited to, a computing device (such as explained below with reference to FIG. 10).

In one or more embodiments, a machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a transformer-based model, a diffusion model, or a combination thereof.

Similarly, in one or more embodiments, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer neural network, a classifier neural network, or a generative adversarial neural network.

In some instances, the artist-based image detection system 102 receives a request (e.g., from the client device 108) to determine a model source or a prompt type for a digital image. For example, the artist-based image detection system 102 obtains the digital image and receives a request to determine a prompt type used to generate the digital image. Some embodiments of server device(s) 106 perform a variety of functions via the digital media management system 104 on the server device(s) 106. To illustrate, the server device(s) 106 (through the artist-based image detection system 102 on the digital media management system 104) performs functions such as, but not limited to, determining a digital image generated by an image generation neural network, processing the digital image utilizing an artist customized model prediction neural network, and generating a prompt type label for the digital image indicating whether the digital image was generated from an artist prompt. In some embodiments, the server device(s) 106 utilizes the artist prompt prediction neural network 114 to determine the prompt type label for the digital image. In some embodiments, the server device(s) 106 trains the artist prompt prediction neural network 114 and/or the artist customized model prediction neural network 116.

Furthermore, as shown in FIG. 1, the system 100 includes the client device 108. In some embodiments, the client device 108 includes, but is not limited to, a mobile device (e.g., a smartphone, a tablet), a laptop computer, a desktop computer, or any other type of computing device, including those explained below with reference to FIG. 10. Some embodiments of client device 108 perform a variety of functions via a client application 110 on client device 108. For example, the client device 108 (through the client application 110) performs functions such as, but not limited to, determining a digital image generated by an image generation neural network, processing the digital image utilizing an artist customized model prediction neural network, and generating a prompt type label for the digital image indicating whether the digital image was generated from an artist prompt. In some embodiments, the client device 108 utilizes the artist prompt prediction neural network 114 to determine the prompt type label for the digital image. In some embodiments, the client device 108 trains the artist prompt prediction neural network 114 and/or the artist customized model prediction neural network 116.

To access the functionalities of the artist-based image detection system 102 (as described above and in greater detail below), in one or more embodiments, a user interacts with the client application 110 on the client device 108. For example, the client application 110 includes one or more software applications (e.g., to detect generated images prompted with artist names in accordance with one or more embodiments described herein) installed on the client device 108, such as a digital media management application and/or an image source identification application. In certain instances, the client application 110 is hosted on the server device(s) 106. Additionally, when hosted on the server device(s) 106, the client application 110 is accessed by the client device 108 through a web browser and/or another online interfacing platform and/or tool. Furthermore, in some embodiments, the client device 108, the server device(s) 106, or another system host one or more databases including digital data.

As illustrated in FIG. 1, in some embodiments, the artist-based image detection system 102 is hosted by the client application 110 on the client device 108 (e.g., additionally, or alternatively to being hosted by the digital media management system 104 on the server device(s) 106). For example, the artist-based image detection system 102 performs the artist-based image generation detection techniques described herein on the client device 108. In some implementations, the artist-based image detection system 102 utilizes the server device(s) 106 to train and implement machine learning models (such as the artist prompt prediction neural network 114 and/or the artist customized model prediction neural network 116). In one or more embodiments, the artist-based image detection system 102 utilizes the server device(s) 106 to train machine learning models (such as the artist prompt prediction neural network 114 and/or the artist customized model prediction neural network 116) and utilizes the client device 108 to implement or apply the machine learning models.

Further, although FIG. 1 illustrates the artist-based image detection system 102 being implemented by a particular component and/or device within the system 100 (e.g., the server device(s) 106 and/or the client device 108), in some embodiments the artist-based image detection system 102 is implemented, in whole or in part, by other computing devices and/or components in the system 100. For instance, in some embodiments, the artist-based image detection system 102 is implemented on another client device. More specifically, in one or more embodiments, the description of (and acts performed by) the artist-based image detection system 102 are implemented by (or performed by) the client application 110 on another client device.

In some embodiments, the client application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106 (e.g., a request to analyze a digital image and determine a source and/or a prompt type for the digital image). In response, the artist-based image detection system 102 on the server device(s) 106 performs operations described herein to utilize the artist prompt prediction neural network 114 and/or the artist customized model prediction neural network 116 to generate classification labels for the digital image. The server device(s) 106 provides the output or results of the operations (e.g., a prompt type label, a prompt name label, an image source label, etc.) to the client device 108. As another example, in some implementations, the artist-based image detection system 102 on the client device 108 performs operations described herein to utilize the artist prompt prediction neural network 114 and/or the artist customized model prediction neural network 116 to generate classification labels for the digital image. The client device 108 provides the output or results of the operations (e.g., a prompt type label, a prompt name label, an image source label, etc.) via a display of the client device 108, and/or transmits the output or results of the operations to another device (e.g., the server device(s) 106 and/or another client device).

Additionally, as shown in FIG. 1, the system 100 includes the network 112. As mentioned above, in some instances, the network 112 enables communication between components of the system 100. In certain embodiments, the network 112 includes a suitable network and communicates using any communication platforms and technologies suitable for transporting data and/or communication signals, examples of which are described with reference to FIG. 10. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

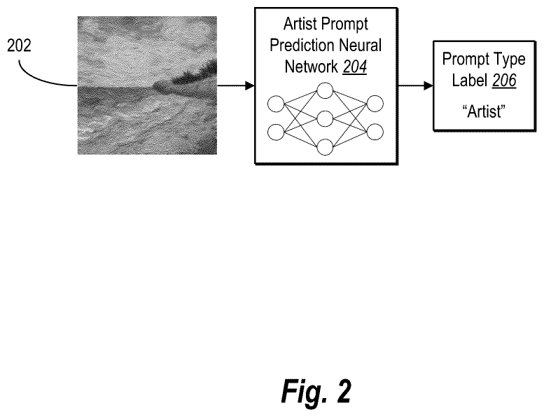

As mentioned above, in some embodiments, the artist-based image detection system 102 detects synthetic images that were generated from artist prompts. To illustrate, FIG. 2 shows the artist-based image detection system 102 generating a prompt type label for a digital image in accordance with one or more embodiments.

Specifically, FIG. 2 shows the artist-based image detection system 102 accessing a digital image 202. For example, the artist-based image detection system 102 obtains a group of digital images generated by an image generation neural network (or a plurality of image generation neural networks), and determines the digital image 202 from the group of digital images. To illustrate, the artist-based image detection system 102 determines the digital image 202 from the group of digital images in response to a request to process the group of digital images.

In addition, FIG. 2 shows the artist-based image detection system 102 processing the digital image 202 utilizing an artist prompt prediction neural network 204 (e.g., the artist prompt prediction neural network 114). In some implementations, the artist-based image detection system 102 trains the artist prompt prediction neural network 204 to detect synthetic images generated from artist prompts comprising indications of specific artists. For example, in some cases, a synthetic image was generated by an image generation neural network using an input prompt that named a specific artist whose style was to be replicated in the synthetic image.

Moreover, FIG. 2 shows the artist-based image detection system 102 generating a prompt type label 206 for the digital image 202. In particular, FIG. 2 shows the artist-based image detection system 102 utilizing the artist prompt prediction neural network 204 to generate the prompt type label 206. For example, the prompt type label 206 indicates whether the digital image 202 was generated from an artist prompt. For instance, in some cases, the prompt type label 206 indicates that the digital image 202 was generated from a prompt that had an indication of a specific artist (e.g., a prompt such as “Generate an image similar to [artist]”).

As described in additional detail below, in some embodiments, the artist-based image detection system 102 generates a novel training dataset for detecting generated images prompted with artist names and generated images from artistic-style customized models. Additionally, in some embodiments, the artist-based image detection system 102 trains the artist prompt prediction neural network 204 and/or an artist customized model prediction neural network on the training dataset to generate classification labels that indicate whether digital images are artist-prompted or generated by an artist-customized model.

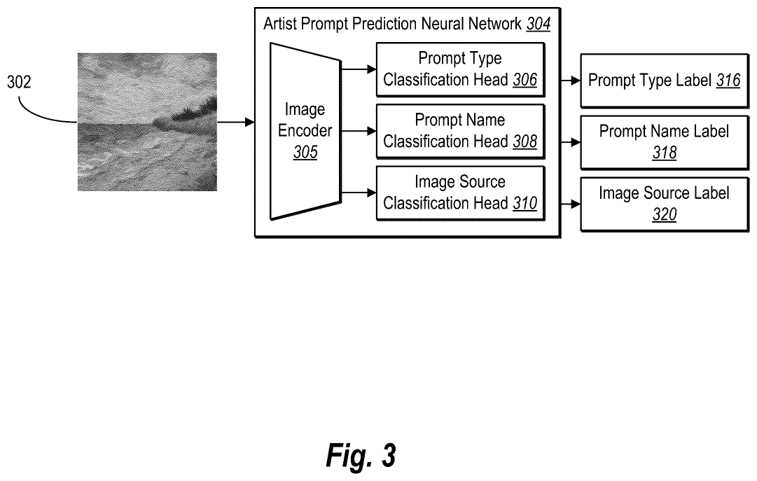

As discussed above, in some embodiments, the artist-based image detection system 102 utilizes an artist prompt prediction neural network to generate labels for a digital image. For instance, FIG. 3 illustrates the artist-based image detection system 102 utilizing an artist prompt prediction neural network to generate a prompt type label, a prompt name label, and an image source label for a digital image in accordance with one or more embodiments.

Specifically, FIG. 3 shows the artist-based image detection system 102 accessing a digital image 302. Furthermore, the artist-based image detection system 102 processes the digital image 302 through an artist prompt prediction neural network 304 (e.g., the artist prompt prediction neural network 204) to generate labels for the digital image 302. To illustrate, the artist prompt prediction neural network 304 includes an image encoder 305 and various classification heads. For example, the artist prompt prediction neural network 304 includes a prompt type classification head 306, a prompt name classification head 308, and an image source classification head 310.

Moreover, as shown in FIG. 3, the artist-based image detection system 102 utilizes the various classification heads of the artist prompt prediction neural network 304 to generate the labels for the digital image 302. For instance, the artist-based image detection system 102 utilizes the prompt type classification head 306 to generate a prompt type label 316. For example, the artist-based image detection system 102 generates a prompt type classification (e.g., artist, style, or content) from one or more embeddings of the digital image 302. To illustrate, the artist-based image detection system 102 utilizes the image encoder 305 to generate the embeddings of the digital image 302 and processes the embeddings through the prompt type classification head 306 to generate the prompt type classification. In some embodiments, and as discussed in additional detail below, the artist-based image detection system 102 provides the prompt type classification (e.g., for display and/or for use in a downstream task) as the prompt type label 316.

In addition, in some implementations, the artist-based image detection system 102 generates a prompt name label 318 for the digital image 302. For instance, the artist-based image detection system 102 processes the embeddings of the digital image 302 utilizing the prompt name classification head 308 to generate a prompt name classification (e.g., the name of a particular artist). In some implementations, the artist-based image detection system 102 provides the prompt name classification as the prompt name label 318.

In some implementations, the artist-based image detection system 102 provides an artist name as the prompt name label 318 for digital images that have a prompt type label 316 of artist prompt. Additionally, in some implementations, the artist-based image detection system 102 provides “N/A” (not applicable) or a similar label as the prompt name label 318 for digital images that have a prompt type label 316 of style prompt or content prompt. Alternatively, in some embodiments, the artist-based image detection system 102 provides a style name or a content name as the prompt name label 318 for digital images having prompt type labels of style prompt or content prompt. In some cases, determining names for style prompts and/or content prompts helps the artist-based image detection system 102 to train the artist prompt prediction neural network 304 to accurately determine the prompt type label 316 for artist prompted images.

Moreover, in some embodiments, the artist-based image detection system 102 generates an image source label 320 for the digital image 302. For example, the artist-based image detection system 102 processes the embeddings of the digital image 302 utilizing the image source classification head 310 to generate an image source classification (e.g., an identification of an image generation neural network that generated the digital image 302). In some implementations, the artist-based image detection system 102 provides the image source classification as the image source label 320.

To further illustrate, in some embodiments, the artist-based image detection system 102 detects artist-prompted images by solving a multi-label image classification problem. In some implementations, the primary task of the artist-based image detection system 102 (e.g., utilizing the artist prompt prediction neural network 304) is prompt type label classification, with particular emphasis on correct detection of images generated with artist prompts. In some embodiments, the artist-based image detection system 102 also uses the artist prompt prediction neural network 304 to predict the artist's name used in the prompt (for those images that were generated with artist prompts) and to predict the image source (e.g., identify the image generation neural network). In some cases, training the artist prompt prediction neural network 304 to predict artist names and image sources encourages the artist prompt prediction neural network 304 to learn features that help with the main task of prompt type classification. In one or more alternative embodiments, the artist-based image detection system 102 utilizes the artist prompt prediction neural network 304 to generate a single label (e.g., the prompt type label 316) indicating whether the digital image 302 was generated utilizing a prompt tailored to a specific artist.

In some embodiments, that artist-based image detection system 102 utilizes a vision transformer for the image encoder 305. For example, the image encoder 305 includes a vision transformer that uses transformer-based neural network layers to encode the digital image 302 into a plurality of patch-based embeddings. Moreover, in some embodiments, each classification head (the prompt type classification head 306, the prompt name classification head 308, and the image source classification head 310) includes a multilayer perceptron (MLP) with one hidden layer.

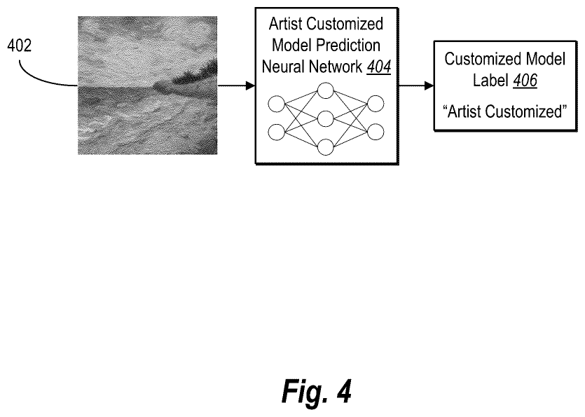

As mentioned, in some embodiments, the artist-based image detection system 102 detects synthetic images that were generated by a customized image generation neural network. For instance, FIG. 4 illustrates the artist-based image detection system 102 generating a customized model label for a digital image in accordance with one or more embodiments.

Specifically, FIG. 4 shows the artist-based image detection system 102 accessing a digital image 402. For example, the artist-based image detection system 102 obtains a group of digital images generated by an image generation neural network, and determines the digital image 402 from the group of digital images. To illustrate, the artist-based image detection system 102 accesses the digital image 402 and determines the digital image 402 from the group of digital images in response to a request to process the group of digital images.

In addition, FIG. 4 shows the artist-based image detection system 102 processing the digital image 402 utilizing an artist customized model prediction neural network 404 (e.g., the artist customized model prediction neural network 116). In some implementations, the artist-based image detection system 102 trains the artist customized model prediction neural network 404 to detect synthetic images generated by one or more neural networks customized with a set of artist-specific training data. For example, in some cases, a synthetic image is generated by an image generation neural network finetuned on works (e.g., digital images) of a particular artist to recreate that artist's style in subsequently generated images.

Moreover, FIG. 4 shows the artist-based image detection system 102 generating a customized model label 406 for the digital image 402. In particular, FIG. 4 shows the artist-based image detection system 102 utilizing the artist customized model prediction neural network 404 to generate the customized model label 406. For example, the customized model label 406 indicates whether the digital image 402 was generated by a customized image generation neural network finetuned with artist-specific image data. For instance, in some cases, the customized model label 406 indicates that the digital image 402 was generated by a customized image generation model that was specifically customized to replicate the style of artistic works of a particular artist. In some embodiments, the artist-based image detection system 102 utilizes a customized model prediction head of the artist customized model prediction neural network 404 to generate the customized model label 406 (e.g., similar to the description above of using the prompt type classification head 306 to generate the prompt type label 316).

Alternatively, in some embodiments, the artist-based image detection system 102 generates the customized model label 406 as an image source label. For example, the artist-based image detection system 102 determines that a source of the digital image 402 is a customized generative model trained on a specific artist's images. For example, the artist-based image detection system 102 trains the artist customized model prediction neural network 404 using a training dataset that distinguishes between customized generative models and non-customized generative models. In some embodiments, the artist customized model prediction neural network 404 generates a customized model label indicating a source of a digital image and whether the source is a customized generative model (or a plurality of separate labels indicating the above).

To further illustrate, in some embodiments, the artist customized model prediction neural network 404 is the same or a similar model as the artist prompt prediction neural networks described above (e.g., the artist prompt prediction neural network 304), with which the artist-based image detection system 102 generates the customized model label 406 as an image source label indicating the source of the digital image 402 (e.g., a specific customized generative model). Moreover, in some embodiments, the artist customized model prediction neural network 404 has a customized model prediction head (e.g., similar to the image source classification head 310) trained to identify specific customized generative models as sources. For example, the artist-based image detection system 102 generates the customized model label 406 for the digital image 402 by utilizing a customized model prediction head of the artist customized model prediction neural network 404 to generate a source classification indicating that the digital image 402 was generated by a customized image generation neural network.

Furthermore, in some embodiments, the artist-based image detection system 102 uses the artist customized model prediction neural network 404 to generate a plurality of additional labels for a digital image. For example, in addition to the customized model label 406, the artist-based image detection system 102 generates (e.g., via one or more additional classification heads) a model name label and/or an artist name label for the customized model. For instance, the artist-based image detection system 102 determines that the digital image 402 was generated by a customized generative neural network and determines a name of the customized generative neural network and a name of an artist whose works were used to finetune the customized generative neural network. Thus, in some implementations, the artist-based image detection system 102 generates a customized model label (e.g., “artist customized”), a model name label, and an artist name label for the digital image.

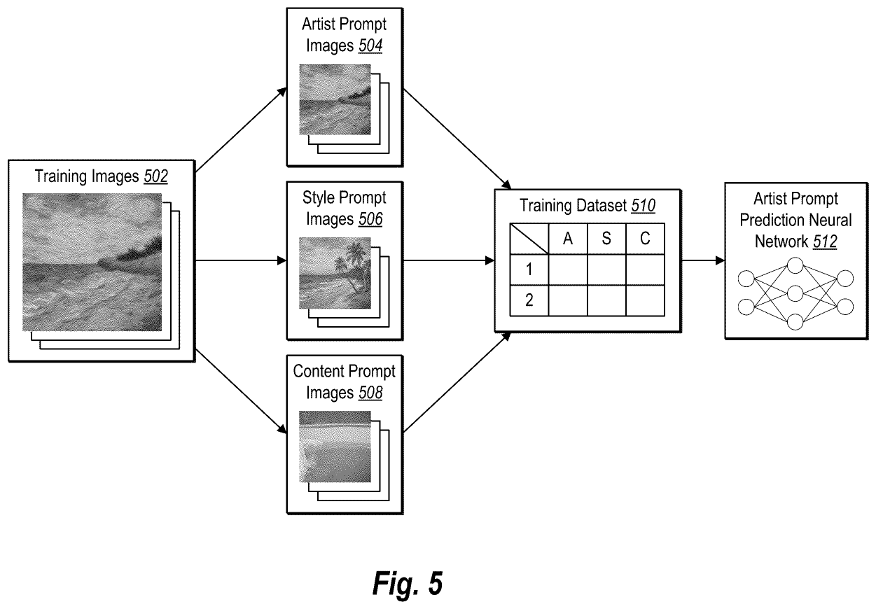

As mentioned above, in some embodiments, the artist-based image detection system 102 prepares a training dataset for a prediction neural network (e.g., an artist prompt prediction neural network or an artist customized model prediction neural network). For instance, FIG. 5 illustrates the artist-based image detection system 102 generating a training dataset for an artist prompt prediction neural network in accordance with one or more embodiments.

Specifically, FIG. 5 shows the artist-based image detection system 102 obtaining a set of training images 502. In some embodiments, the set of training images 502 includes images generated by one or more image generation neural network from various types of prompts. Moreover, in some embodiments, the artist-based image detection system 102 sorts the training images 502 based on the types of prompts used to generate the training images 502. For example, the artist-based image detection system 102 sorts the training images 502 into a batch of artist prompt images 504 (e.g., images generated from artist prompts), a batch of style prompt images 506 (e.g., images generated from style prompts), and a batch of content prompt images 508 (e.g., images generated from content prompts).

Moreover, in some implementations, the artist-based image detection system 102 generates a training dataset 510. For example, the artist-based image detection system 102 includes a first batch of images generated from artist prompts (e.g., the artist prompt images 504) and a second batch of images generated from non-artist prompts (e.g., the style prompt images 506 and/or the content prompt images 508) in the training dataset 510. In some implementations, the artist-based image detection system 102 includes a first batch of images generated from artist prompts (e.g., the artist prompt images 504), a second batch of images generated from style prompts (e.g., the style prompt images 506), and a third batch of images generated from content prompts (e.g., the content prompt images 508) in the training dataset 510. Furthermore, in one or more embodiments, the artist-based image detection system 102 includes the corresponding labels with the images in the training dataset 510, such that the training dataset 510 includes image-label pairs (e.g., an image generated from an artist prompt and the ground truth prompt type label).

To further illustrate, in some embodiments, the artist-based image detection system 102 accesses a first set of images generated from artist prompts by a first image generation neural network and includes the first set of images in the first batch of images (e.g., the artist prompt image batch). Similarly, the artist-based image detection system 102 accesses a second set of images generated from style prompts by the first image generation neural network and includes the second set of images in the second batch of images (e.g., the style prompt image batch). Relatedly, the artist-based image detection system 102 accesses a third set of images generated from content prompts by the first image generation neural network and includes the third set of images in the third batch of images (e.g., the content prompt image batch).

As mentioned, in some implementations, the artist-based image detection system 102 draws from multiple image generation sources to prepare the training dataset 510. For instance, the artist-based image detection system 102 accesses an additional set of images generated from artist prompts by a second image generation neural network and includes the additional set of images in the first batch of images (e.g., the artist prompt image batch) with the first set of images generated by the first image generation neural network.

Additionally, as shown in FIG. 5, the artist-based image detection system 102 uses the training dataset 510 for training an artist prompt prediction neural network 512 (e.g., the artist prompt prediction neural network 304). In addition, in some embodiments, the artist-based image detection system 102 uses the training dataset 510 to evaluate the effectiveness of the artist prompt prediction neural network 512. For example, the artist-based image detection system 102 uses a portion of the training dataset 510 to train the artist prompt prediction neural network 512 to predict the presence of artist names in the corresponding prompts used to generate digital images, and uses another portion of the training dataset 510 to test that the artist prompt prediction neural network 512 accurately distinguishes prompts that specify an artist (artist prompts), those that describe a general artistic style (style prompts), and those that do not contain a stylistic reference but mention content to portray (content prompts).

To further illustrate generation of the training dataset 510, in some embodiments, the artist-based image detection system 102 uses a variety of image sources to enhance the robustness of the artist prompt prediction neural network 512 to detecting artist-based images from different generative models. For example, in some implementations, the artist-based image detection system 102 obtains a batch of real images of various artists'works. Additionally, the artist-based image detection system 102 generates a list of artist labels for this batch. In some embodiments, the artist-based image detection system 102 accesses several hundred of the most frequently occurring artists and obtains a list of generic styles by refining a bank of styles based on typical user prompts. Moreover, the artist-based image detection system 102 generates a content list of subjects that are commonly featured in artwork. In some cases, the artist-based image detection system 102 annotates the real images with a single prompt type label, depending on whether the image's caption contains a label from an artist, style, or content list.

Furthermore, in some embodiments, the artist-based image detection system 102 obtains images for the training dataset 510 from various image generation models. For example, the artist-based image detection system 102 acquires imagery from a text-to-image model, along with corresponding generation prompts. The artist-based image detection system 102 annotates prompt type labels for the images depending on whether an image's prompt contains an artist name, a general style reference, or more generally a content reference.

In addition, in some embodiments, the artist-based image detection system 102 uses an additional text-to-image generative model to directly generate images for the training dataset using prompt templates. For example, the artist-based image detection system 102 generates artist-prompted images using this generative model by prompting the model with “a picture of <content> in the style of <artist>” by inserting a desired subject as the content and an artist name as the specific artist to imitate.

As discussed above in connection with FIG. 4, in some embodiments, the artist-based image detection system 102 utilizes an artist customized model prediction neural network to generate customized model labels for digital images. Furthermore, in some embodiments, the artist-based image detection system 102 prepares a training dataset for the artist customized model prediction neural network. For example, the artist-based image detection system 102 generates the training dataset by accessing a first batch of images generated by a first image generation neural network customized with artist-specific training data and includes the first batch in the training dataset. Additionally, the artist-based image detection system 102 accesses a second batch of images generated by a second image generation neural network trained with artist-agnostic training data (e.g., data that does not emphasize works of a specific artist) and includes the second batch in the training dataset.

To further illustrate, in some embodiments, the artist-based image detection system 102 uses a customized model to generate a batch of training data for the training dataset 510. For example, the artist-based image detection system 102 generates training images using a text-to-image model finetuned on a specific artist's works to reproduce that artist's style in subsequently generated images. Moreover, in some implementations, the artist-based image detection system 102 generates multiple (e.g., numerous) customized image generation models, each based on a different particular artist's works, and each contributing to the training dataset to train and evaluate the artist customized model prediction neural network.

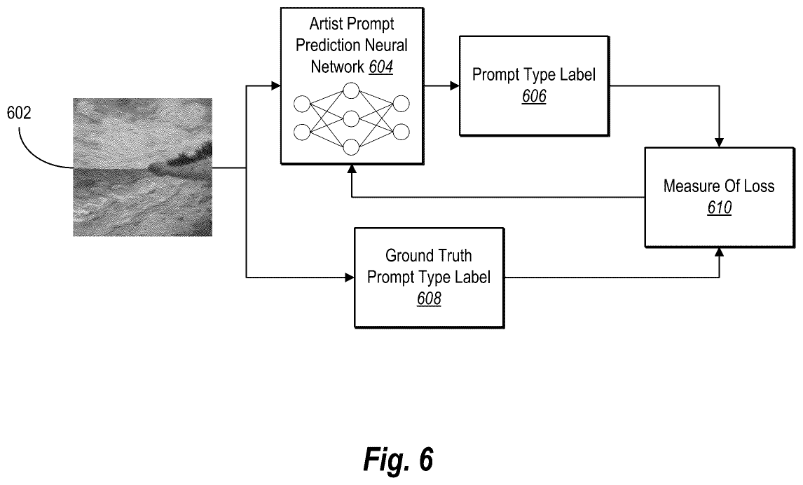

As mentioned, in some embodiments, the artist-based image detection system 102 trains a prediction neural network (e.g., an artist prompt prediction neural network or an artist customized model prediction neural network). For instance, FIG. 6 illustrates the artist-based image detection system 102 modifying parameters of an artist prompt prediction neural network in accordance with one or more embodiments.

Specifically, FIG. 6 shows the artist-based image detection system 102 obtaining a digital image 602. Additionally, FIG. 6 shows the artist-based image detection system 102 utilizing an artist prompt prediction neural network 604 (e.g., the artist prompt prediction neural network 512) to generate a prompt type label 606 for the digital image 602. For example, the artist-based image detection system 102 uses techniques described above to generate the prompt type label 606 utilizing a prompt type classification head of the artist prompt prediction neural network 604.

In addition, FIG. 6 shows the artist-based image detection system 102 obtaining a ground truth prompt type label 608 for the digital image 602. For example, the artist-based image detection system 102 accesses a label indicating what type of prompt (e.g., artist, style, or content) was used to generate the digital image 602. More specifically, as indicated previously, the artist-based image detection system 102 obtains the ground truth prompt type label 608 from a training dataset.

Moreover, FIG. 6 shows the artist-based image detection system 102 determining a measure of loss 610 based on the prompt type label 606 and the ground truth prompt type label 608. For example, the artist-based image detection system 102 compares the prompt type label 606 with the ground truth prompt type label 608 to determine the measure of loss 610 indicating differences between the prompt type label 606 and the ground truth prompt type label 608. In some embodiments, the artist-based image detection system 102 uses a cross-entropy loss as the measure of loss 610.

Furthermore, as shown in FIG. 6, the artist-based image detection system 102 uses the measure of loss 610 to train the artist prompt prediction neural network 604. For instance, the artist-based image detection system 102 adjusts parameters of the artist prompt prediction neural network 604 to reduce the measure of loss 610 (e.g., on a subsequent training iteration). Similarly, in some embodiments, the artist-based image detection system 102 adjusts parameters of an artist customized model prediction neural network to reduce a measure of loss (e.g., a cross-entropy loss) based on the customized model label and a ground truth customized model label. Accordingly, the artist-based image detection system 102 trains the artist prompt prediction neural network 604 using the measure of loss 610 to reduce differences between the prompt type label 606 and the ground truth prompt type label 608.

As just mentioned, in some implementations, the artist-based image detection system 102 trains the artist prompt prediction neural network 604 by adjusting parameters of the artist prompt prediction neural network 604. More particularly, in some implementations, the artist-based image detection system 102 jointly adjusts parameters of several components of the artist prompt prediction neural network 604. For example, the artist-based image detection system 102 adjusts parameters of a prompt type classification head (e.g., the prompt type classification head 306), adjusts parameters of a prompt name classification head (e.g., the prompt name classification head 308), and adjusts parameters of an image source classification head (e.g., the image source classification head 310) to reduce the measure of loss 610.

Furthermore, in some embodiments, the artist-based image detection system 102 tunes an image encoder (e.g., the image encoder 305) of the artist prompt prediction neural network 604 simultaneously with the classification heads. For instance, the artist-based image detection system 102 adjusts parameters of the image encoder of the artist prompt prediction neural network 604 (e.g., together with the other parameters of the artist prompt prediction neural network 604). For example, the artist-based image detection system 102 begins with pretrained weights of the image encoder and tunes all model parameters on the training dataset.

Furthermore, in one or more embodiments, the artist-based image detection system 102 utilizes a similar training process as described in FIG. 6 to train an artist customized model prediction neural network (e.g., as described in FIG. 4). For instance, the artist-based image detection system 102 compares a customized model label generated by the artist customized model prediction neural network to a ground truth customized model label to determine a measure of loss. Additionally, the artist-based image detection system 102 utilizes the measure of loss to modify parameters of the artist customized model prediction neural network to reduce differences between the customized model label and the ground truth customized model label.

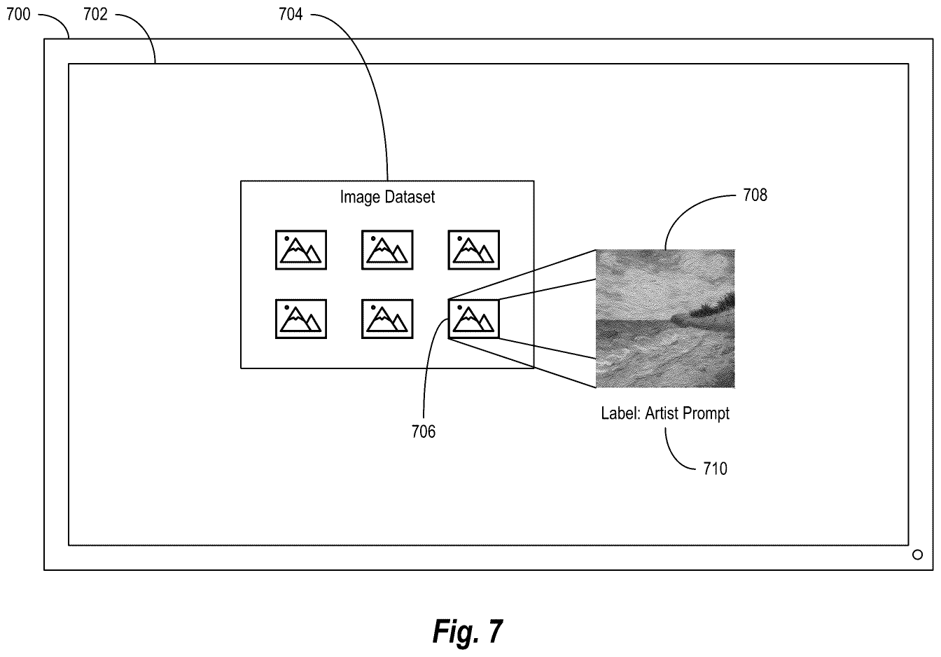

As discussed, in some embodiments, the artist-based image detection system 102 provides labels that classify digital images based on whether they were generated to emulate a style of a particular artist to a client device. For instance, FIG. 7 illustrates the artist-based image detection system 102 providing a prompt type label for a digital image for display via a graphical user interface in accordance with one or more embodiments.

Specifically, FIG. 7 shows a computing device 700 with a graphical user interface 702. The computing device displays a representation of an image dataset 704 via the graphical user interface 702. Moreover, based on a user selection of an image representation 706 (e.g., a thumbnail, a filename, an icon, etc.) of a digital image 708, the artist-based image detection system 102 analyzes the digital image 708 to determine a prompt type label for the digital image 708. For instance, as discussed herein, the artist-based image detection system 102 utilizes an artist prompt prediction neural network to generate a prompt type label 710 indicating a prompt type used to generate the digital image 708. In one or more additional embodiments, the artist-based image detection system 102 generates prompt type labels (and/or one or more other labels) for a plurality of images in the image dataset 704, such as in response to a batch request to label the digital images in the image dataset 704.

For example, and as shown in FIG. 7, the artist-based image detection system 102 determines the digital image 708 in response to a user query for prompt information about the digital image 708. Furthermore, the artist-based image detection system 102 provides the prompt type label 710 for display via the graphical user interface 702. Additionally, in one or more embodiments, the artist-based image detection system 102 generates and provides additional labels for display via the graphical user interface 702, such as by generating and providing prompt name labels and/or image source labels for one or more digital images in the image dataset 704.

Moreover, as discussed above, in some embodiments, the artist-based image detection system 102 uses an artist customized model prediction neural network to analyze the digital image 708. For example, the artist-based image detection system 102 determines the digital image 708 in response to a user query for customization information about the digital image 708. Moreover, the artist-based image detection system 102 provides a customized model label for the digital image 708 for display via the graphical user interface 702.

Experiments were conducted to evaluate the artist-based image detection system 102 using an artist prompt prediction neural network. In particular, a dataset was prepared that includes a training batch and two testing batches. In this way, the artist-based image detection system 102 was tested on two types of generalization: unseen content and unseen artists. The training batch includes images of one hundred artists for to be classified by the artist prompt prediction neural network and four hundred seen content subjects. The first testing batch (evaluating generalization to unseen content) includes one hundred held-out content subjects not seen during training. The second testing batch (evaluating generalization to unseen artists) includes ten held-out artists not seen during training. For this batch, the artist-based image detection system 102 was tested to see if the artist prompt prediction neural network correctly classifies the images'prompt type, while less importance is placed on correctly classifying the artists'names.

On both of the two testing batches, the artist-based image detection system 102 correctly predicts the prompt type at 67% for the unseen content batch and 86% for the unseen artists batch. Furthermore, over a closed set of one hundred artists and unseen content, the artist prompt prediction neural network achieved a 73% accuracy for artist name classification, which is respectable compared to prior work on learning style similarity. In addition, the artist-based image detection system 102 consistently performed highly on image source classification, attaining 99% accuracy on both testing batches.

In sum, the artist-based image detection system 102 delivers accurate performance while providing novel capabilities of artist prompt detection and artist customized model detection. In particular, the artist-based image detection system 102 is effective in generalizing to unseen artists and content. Additionally, on a subset of artists, the artist-based image detection system 102 achieves high-precision detection of artist-conditioned images.

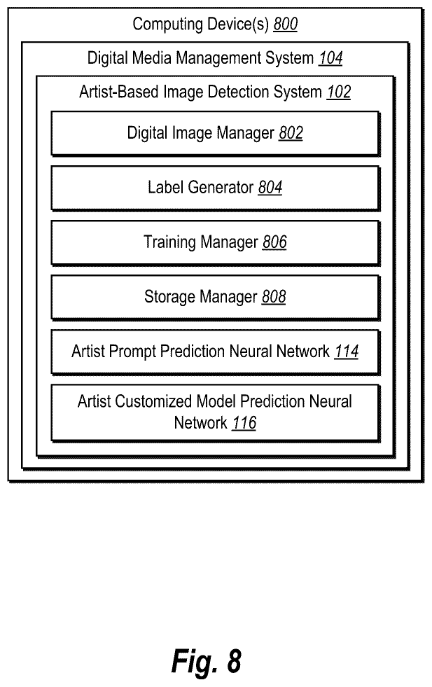

Turning now to FIG. 8, additional detail will be provided regarding components and capabilities of one or more embodiments of the artist-based image detection system 102. In particular, FIG. 8 illustrates an example artist-based image detection system 102 executed by a computing device(s) 800 (e.g., the server device(s) 106 or the client device 108). As shown by the embodiment of FIG. 8, the computing device(s) 800 includes or hosts the digital media management system 104 and/or the artist-based image detection system 102. Furthermore, as shown in FIG. 8, the artist-based image detection system 102 includes a digital image manager 802, a label generator 804, a training manager 806, and a storage manager 808.

As shown in FIG. 8, the artist-based image detection system 102 includes a digital image manager 802. In some implementations, the digital image manager 802 determines digital images generated by one or more image generation neural networks. For example, in some implementations, the digital image manager 802 accesses a group of generated images and determines a digital image from the group of generated images to query with a prompt type or source model type.

In addition, as shown in FIG. 8, the artist-based image detection system 102 includes a label generator 804. In some implementations, the label generator 804 generates one or more labels for a digital image, such as a prompt type label. For instance, the label generator 804 utilizes the artist prompt prediction neural network 114 to generate a prompt type label indicating whether the digital image was generated from an artist prompt identifying a particular artist to replicate in style. Moreover, in some implementations, the label generator 804 utilizes one or more classification heads of a neural network, such as the artist prompt prediction neural network 114, to generate labels for digital images.

Moreover, as shown in FIG. 8, the artist-based image detection system 102 includes a training manager 806. In some implementations, the training manager 806 trains (e.g., modifies parameters of) one or more machine learning models, as described above, including the artist prompt prediction neural network 114 and/or the artist customized model prediction neural network 116. For example, the training manager 806 adjusts parameters of an image encoder, a prompt type classification head, a prompt name classification head, and/or an image source classification head of the artist prompt prediction neural network 114.

Furthermore, as shown in FIG. 8, the artist-based image detection system 102 includes a storage manager 808. In some implementations, the storage manager 808 stores information (e.g., via one or more memory devices) on behalf of the artist-based image detection system 102. For example, the storage manager 808 stores files of digital images, parameters of one or more machine learning models (e.g., the artist prompt prediction neural network 114 and/or the artist customized model prediction neural network 116), and labels for image classifications associated with the digital images.

Each of the components 802-808 of the artist-based image detection system 102 includes software, hardware, or both. For example, the components 802-808 include one or more instructions stored on a computer-readable storage medium and executable by processors of one or more computing devices, such as a client device or server device. When executed by the one or more processors, in some implementations, the computer-executable instructions of the artist-based image detection system 102 cause the computing device(s) to perform the methods described herein. Alternatively, in one or more implementations, the components 802-808 include hardware, such as a special purpose processing device to perform a certain function or group of functions. Alternatively, in some implementations, the components 802-808 of the artist-based image detection system 102 include a combination of computer-executable instructions and hardware.

Furthermore, the components 802-808 of the artist-based image detection system 102 are, for example, implemented as one or more operating systems, as one or more stand-alone applications, as one or more modules of an application, as one or more plug-ins, as one or more library functions, as one or more functions callable by other applications, and/or as a cloud-computing model. Thus, in some implementations, the components 802-808 are implemented as a stand-alone application, such as a desktop or mobile application. Furthermore, in various implementations, the components 802-808 are implemented as one or more web-based applications hosted on a remote server. In some implementations, the components 802-808 are implemented in a suite of mobile device applications or “apps.” To illustrate, in some implementations, the components 802-808 are implemented in an application, including but not limited to Adobe Creative Cloud and Adobe Firefly. The foregoing are either registered trademarks or trademarks of Adobe in the United States and/or other countries.

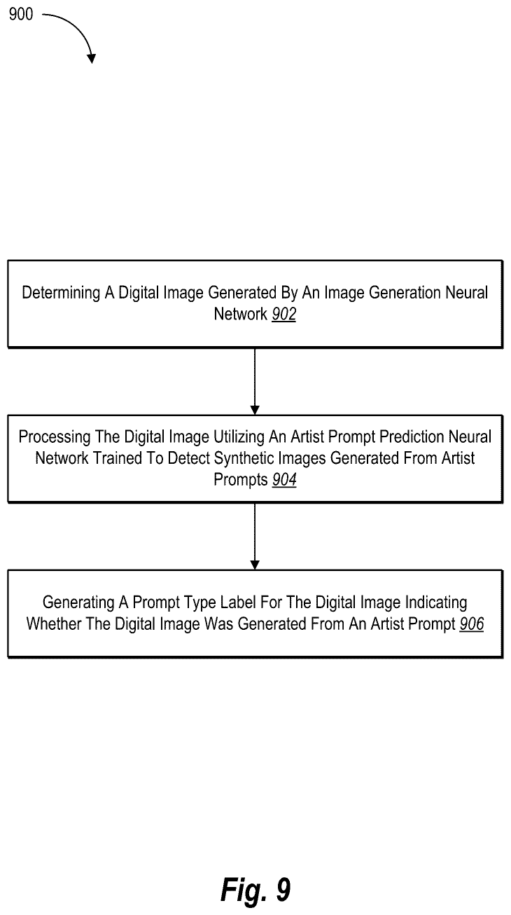

FIGS. 1-8, the corresponding text, and the examples provide a number of different methods, systems, devices, and non-transitory computer-readable media of the artist-based image detection system 102. In addition to the foregoing, one or more embodiments are described in terms of flowcharts comprising acts for accomplishing a particular result, as shown in FIG. 9. In some implementations, the processes of the artist-based image detection system 102 are performed with more or fewer acts. Furthermore, in various implementations, the acts are performed in differing orders. Additionally, in some implementations, the acts described herein are repeated or performed in parallel with one another or in parallel with different instances of the same or similar acts.

As mentioned, FIG. 9 illustrates a flowchart of a series of acts 900 for detecting generated images prompted with specific artist names in accordance with one or more implementations. While FIG. 9 illustrates acts according to one implementation, alternative implementations omit, add to, reorder, and/or modify any of the acts shown in FIG. 9. In one or more implementations, the acts of FIG. 9 are performed as part of a method (e.g., a computer-implemented method). Alternatively, in one or more implementations, a non-transitory computer-readable storage medium comprises instructions that, when executed by one or more processors, cause a computing device to perform the acts of FIG. 9. In some implementations, a system performs the acts of FIG. 9.

As shown in FIG. 9, the series of acts 900 includes an act 902 of determining a digital image generated by an image generation neural network, an act 904 of processing the digital image utilizing an artist prompt prediction neural network trained to detect synthetic images generated from artist prompts, and an act 906 of generating a prompt type label for the digital image indicating whether the digital image was generated from an artist prompt.

In particular, in some implementations, the act 902 includes determining, by at least one processor, a digital image generated by an image generation neural network, the act 904 includes processing the digital image utilizing an artist prompt prediction neural network trained to detect synthetic images generated from artist prompts comprising indications of specific artists, and the act 906 includes generating, utilizing the artist prompt prediction neural network, a prompt type label for the digital image indicating whether the digital image was generated from an artist prompt comprising an indication of a specific artist.

For example, in some implementations, the series of acts 900 includes generating, for the artist prompt prediction neural network, a training dataset comprising a first batch of images generated from artist prompts and a second batch of images generated from non-artist prompts. Moreover, in some implementations, the series of acts 900 includes generating the training dataset by: accessing, for the first batch of images, a first set of images generated from artist prompts by a first image generation neural network; and accessing, for the first batch of images, a second set of images generated from artist prompts by a second image generation neural network. Furthermore, in some implementations, the series of acts 900 includes adjusting parameters of the artist prompt prediction neural network to reduce a measure of loss determined by comparing the prompt type label for the digital image with a ground truth prompt type label.

Additionally, in some implementations, the series of acts 900 includes generating the prompt type label for the digital image by utilizing a prompt type classification head of the artist prompt prediction neural network to generate a prompt type classification from embeddings of the digital image. Moreover, in some implementations, the series of acts 900 includes generating a prompt name label for the digital image by utilizing a prompt name classification head of the artist prompt prediction neural network to generate a prompt name classification from the embeddings of the digital image. Furthermore, in some implementations, the series of acts 900 includes generating an image source label for the digital image by utilizing an image source classification head of the artist prompt prediction neural network to generate an image source classification from the embeddings of the digital image.

Additionally, in some implementations, the series of acts 900 includes determining the digital image in response to a user query for prompt information about the digital image; and providing, in response to determining the digital image, the prompt type label for display via a graphical user interface of a client device.

In addition, in some implementations, the series of acts 900 includes determining a digital image generated by an image generation neural network; processing the digital image utilizing an artist customized model prediction neural network trained to detect synthetic images generated by one or more neural networks customized with a set of artist-specific training data; and generating, utilizing the artist customized model prediction neural network, a customized model label for the digital image indicating whether the digital image was generated by a customized image generation neural network finetuned with artist-specific image data.

For example, in some implementations, the series of acts 900 includes generating the customized model label for the digital image by utilizing a customized model prediction head of the artist customized model prediction neural network to generate a source classification indicating that the digital image was generated by the customized image generation neural network. Moreover, in some implementations, the series of acts 900 includes adjusting parameters of the artist customized model prediction neural network to reduce a cross-entropy loss based on the customized model label and a ground truth customized model label.

Furthermore, in some implementations, the series of acts 900 includes generating, for the artist customized model prediction neural network, a training dataset by: accessing a first batch of images generated by a first image generation neural network customized with artist-specific training data; and accessing a second batch of images generated by a second image generation neural network trained with artist-agnostic training data. Additionally, in some implementations, the series of acts 900 includes determining the digital image in response to a user query for customization information about the digital image; and providing, in response to determining the digital image, the customized model label for display via a graphical user interface of a client device.

In addition, in some implementations, the series of acts 900 includes determining a digital image generated by an image generation neural network; processing the digital image utilizing an artist prompt prediction neural network trained to detect synthetic images generated from artist prompts comprising indications of specific artists; and generating, utilizing the artist prompt prediction neural network, a prompt type label for the digital image indicating whether the digital image was generated from an artist prompt comprising an indication of a specific artist.

For example, in some implementations, the series of acts 900 includes generating, for the artist prompt prediction neural network, a training dataset comprising a first batch of images generated from artist prompts, a second batch of images generated from style prompts, and a third batch of images generated from content prompts. Moreover, in some implementations, the series of acts 900 includes generating the training dataset by: accessing, for the first batch of images, a first set of images generated from artist prompts by a first image generation neural network; and accessing, for the second batch of images, a second set of images generated from style prompts by the first image generation neural network. Furthermore, in some implementations, the series of acts 900 includes adjusting parameters of the artist prompt prediction neural network to reduce a cross-entropy loss determined by comparing the prompt type label for the digital image with a ground truth prompt type label.

Additionally, in some implementations, the series of acts 900 includes generating the prompt type label for the digital image by utilizing a prompt type classification head of the artist prompt prediction neural network; generating a prompt name label for the digital image by utilizing a prompt name classification head of the artist prompt prediction neural network; and generating an image source label for the digital image by utilizing an image source classification head of the artist prompt prediction neural network. Moreover, in some implementations, the series of acts 900 includes adjusting parameters of the artist prompt prediction neural network to reduce a measure of loss by: adjusting prompt type parameters of the prompt type classification head; adjusting prompt name parameters of the prompt name classification head; and adjusting image source parameters of the image source classification head. Furthermore, in some implementations, the series of acts 900 includes adjusting the parameters of the artist prompt prediction neural network to reduce the measure of loss by adjusting encoder parameters of an image encoder of the artist prompt prediction neural network.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 10 illustrates, in block diagram form, an example computing device 1000 (e.g., the computing device(s) 800, the client device 108, and/or the server device(s) 106) that may be configured to perform one or more of the processes described above. As shown by FIG. 10, the computing device can comprise a processor(s) 1002, memory 1004, a storage device 1006, an I/O interface 1008, and a communication interface 1010.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them. The computing device 1000 includes memory 1004, which is coupled to the processor(s) 1002. The memory 1004 may be used for storing data, metadata, and programs for execution by the processor(s). The memory 1004 may include one or more of volatile and non-volatile memories. The memory 1004 may be internal or distributed memory. The computing device 1000 includes a storage device 1006 includes storage for storing data or instructions. As an example, and not by way of limitation, storage device 1006 can comprise a non-transitory storage medium described above. The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices (e.g., computing device 1000) or one or more networks. The computing device 1000 can further include a bus 1012. The bus 1012 can comprise hardware, software, or both that couples components of computing device 1000 to each other.

What is claimed is:

1. A computer-implemented method comprising:
determining, by at least one processor, a digital image generated by an image generation neural network;
processing the digital image utilizing an artist prompt prediction neural network trained to detect synthetic images generated from artist prompts comprising indications of specific artists; and
generating, utilizing the artist prompt prediction neural network, a prompt type label for the digital image indicating whether the digital image was generated from an artist prompt comprising an indication of a specific artist.

2. The computer-implemented method of claim 1, further comprising generating, for the artist prompt prediction neural network, a training dataset comprising a first batch of images generated from artist prompts and a second batch of images generated from non-artist prompts.

3. The computer-implemented method of claim 2, wherein generating the training dataset comprises:
accessing, for the first batch of images, a first set of images generated from artist prompts by a first image generation neural network; and
accessing, for the first batch of images, a second set of images generated from artist prompts by a second image generation neural network.

4. The computer-implemented method of claim 1, further comprising adjusting parameters of the artist prompt prediction neural network to reduce a measure of loss determined by comparing the prompt type label for the digital image with a ground truth prompt type label.

5. The computer-implemented method of claim 1, wherein generating the prompt type label for the digital image comprises utilizing a prompt type classification head of the artist prompt prediction neural network to generate a prompt type classification from embeddings of the digital image.

6. The computer-implemented method of claim 5, further comprising generating a prompt name label for the digital image by utilizing a prompt name classification head of the artist prompt prediction neural network to generate a prompt name classification from the embeddings of the digital image.

7. The computer-implemented method of claim 5, further comprising generating an image source label for the digital image by utilizing an image source classification head of the artist prompt prediction neural network to generate an image source classification from the embeddings of the digital image.

8. The computer-implemented method of claim 1, further comprising:
determining the digital image in response to a user query for prompt information about the digital image; and
providing, in response to determining the digital image, the prompt type label for display via a graphical user interface of a client device.

9. A system comprising:
one or more memory devices; and
one or more processors coupled to the one or more memory devices that cause the system to perform operations comprising:
determining a digital image generated by an image generation neural network;
processing the digital image utilizing an artist customized model prediction neural network trained to detect synthetic images generated by one or more neural networks customized with a set of artist-specific training data; and
generating, utilizing the artist customized model prediction neural network, a customized model label for the digital image indicating whether the digital image was generated by a customized image generation neural network finetuned with artist-specific image data.

10. The system of claim 9, wherein generating the customized model label for the digital image comprises utilizing a customized model prediction head of the artist customized model prediction neural network to generate a source classification indicating that the digital image was generated by the customized image generation neural network.

11. The system of claim 9, wherein the operations further comprise adjusting parameters of the artist customized model prediction neural network to reduce a cross-entropy loss based on the customized model label and a ground truth customized model label.

12. The system of claim 9, wherein the operations further comprise generating, for the artist customized model prediction neural network, a training dataset by:
accessing a first batch of images generated by a first image generation neural network customized with artist-specific training data; and
accessing a second batch of images generated by a second image generation neural network trained with artist-agnostic training data.

13. The system of claim 9, wherein the operations further comprise:
determining the digital image in response to a user query for customization information about the digital image; and
providing, in response to determining the digital image, the customized model label for display via a graphical user interface of a client device.

14. A non-transitory computer-readable medium storing instructions thereon that, when executed by at least one processor, cause the at least one processor to perform operations comprising:
determining a digital image generated by an image generation neural network;
processing the digital image utilizing an artist prompt prediction neural network trained to detect synthetic images generated from artist prompts comprising indications of specific artists; and
generating, utilizing the artist prompt prediction neural network, a prompt type label for the digital image indicating whether the digital image was generated from an artist prompt comprising an indication of a specific artist.

15. The non-transitory computer-readable medium of claim 14, wherein the operations further comprise generating, for the artist prompt prediction neural network, a training dataset comprising a first batch of images generated from artist prompts, a second batch of images generated from style prompts, and a third batch of images generated from content prompts.

16. The non-transitory computer-readable medium of claim 15, wherein generating the training dataset comprises:
accessing, for the first batch of images, a first set of images generated from artist prompts by a first image generation neural network; and
accessing, for the second batch of images, a second set of images generated from style prompts by the first image generation neural network.

17. The non-transitory computer-readable medium of claim 14, wherein the operations further comprise adjusting parameters of the artist prompt prediction neural network to reduce a cross-entropy loss determined by comparing the prompt type label for the digital image with a ground truth prompt type label.

18. The non-transitory computer-readable medium of claim 14, wherein the operations further comprise:
generating the prompt type label for the digital image by utilizing a prompt type classification head of the artist prompt prediction neural network;
generating a prompt name label for the digital image by utilizing a prompt name classification head of the artist prompt prediction neural network; and
generating an image source label for the digital image by utilizing an image source classification head of the artist prompt prediction neural network.

19. The non-transitory computer-readable medium of claim 18, wherein the operations further comprise adjusting parameters of the artist prompt prediction neural network to reduce a measure of loss by:
adjusting prompt type parameters of the prompt type classification head;
adjusting prompt name parameters of the prompt name classification head; and
adjusting image source parameters of the image source classification head.

20. The non-transitory computer-readable medium of claim 19, wherein the operations further comprise adjusting the parameters of the artist prompt prediction neural network to reduce the measure of loss by adjusting encoder parameters of an image encoder of the artist prompt prediction neural network.
